(19) United States
(12) Patent Application Publication
(10) Pub. No.: US 2012/0300637 A1
(43) Pub. Date: Nov. 29, 2012

(54) TRANSMISSION APPARATUS AND TRANSMISSION METHOD

(75) Inventors: Yoshikazu SABETTO, Fukuoka (JP); Yukihide Yamasaki, Fukuoka (JP); Mayumi Tsuru, Fukuoka (JP)

(73) Assignees: FUJITSU TELECOM NETWORKS LIMITED, Kawasaki-shi (JP); FUJITSU LIMITED, Kawasaki-shi (JP)

(21) Appl. No.: 13/428,599

(22) Filed: Mar. 23, 2012

(30) Foreign Application Priority Data
May 26, 2011 (JP) 2011-118444

(51) Int. Cl. H04W 28/12

(52) U.S. Cl. 370/236

(57) ABSTRACT

A CPU 16 of a transmission apparatus 2 determines whether reception processing of a CCM frame received from an opposite MEP transmission apparatus 2 is in a congestion state. When the reception processing is in a congestion state, the CPU 16 calculates an adjustment amount for adjusting transmission timing of a CCM frame related to the opposite MEP transmission apparatus 2 so as to decentralize reception processing of CCM frames. The CPU 16 adds the calculated adjustment amount into a CCM frame to be transmitted to a source MEP transmission apparatus 2, and transmits the CCM frame to the source MEP transmission apparatus 2. In case of receiving an adjustment amount from another opposite MEP transmission apparatus 2, the CPU 16 adjusts transmission timing of a CCM frame to be transmitted to the opposite transmission apparatus 2 on the basis of the adjustment amount.

### CROSS-REFERENCE TO RELATED APPLICATION

This application is based upon and claims the benefit of priority of the prior Japanese Patent Application No. 2011-118444, filed on May 26, 2011, the entire contents of which are incorporated herein by reference.

### FIELD

The embodiments discussed herein are directed to a transmission apparatus and a transmission method.

### BACKGROUND

An IP-based network, such as an Ethernet (registered trademark), accommodates a plurality of transmission apparatuses and has a maintenance function for checking continuity between the transmission apparatuses, identifying a fault part on the network, and the like. As a technology with the maintenance function, Ethernet OAM (Operation Administration Management) is known. The Ethernet OAM is standardized, for example, in IEEE (802.1ag), ITU-T (Y1731), and the like. The Ethernet OAM includes a continuity check (CC) function of transmitting and receiving a CCM (Continuity Check Messages) frame between transmission apparatuses on a regular basis thereby quickly detecting a fault, for example, mainly for the purpose of checking for continuity between the transmission apparatuses. Specifically, a transmission apparatus transmits a CCM frame to an opposite transmission apparatus on a regular basis. When the opposite transmission apparatus fails to receive the CCM frame on a regular basis, occurrence of a fault (loss of connectivity (LOC)) between the transmission apparatus and the opposite transmission apparatus is detected.

Furthermore, to check a fault, there is a loop back (LB) function of checking whether a CCM frame is properly returned from the opposite transmission apparatus in accordance with an instruction made by user operation, for example, mainly for the purpose of identifying a fault part and is a function. Moreover, there is a link trace (LT) function of transmitting a CCM frame and checking an acknowledgment of the CCM frame from a relaying transmission apparatus mainly for the purpose of narrowing down a fault part in the event of a fault and is a function.

FIG. 9 is an explanatory diagram illustrating an example of a transmission system and management levels thereof. A transmission system 100A illustrated in FIG. 9 has transmission apparatuses 101, such as a transmission apparatus 101A, a transmission apparatus 101B, a transmission apparatus 101C, a transmission apparatus 101D, and a transmission apparatus 101E; the transmission apparatus 101 is connected to another transmission apparatus 101 by a cable 102. Incidentally, the transmission system 100A has a plurality of management levels as a form of management in a maintenance section between the transmission apparatuses 101. In the example illustrated in FIG. 9, the transmission system 100A has three types of management levels: “A1”, “B1”, and “C1”. At the management level “A1”, the transmission apparatus 101A and the transmission apparatus 101E are set as an MEP (Maintenance End Point) indicating a termination point of a CCM frame. Furthermore, the transmission apparatus 101B, the transmission apparatus 101C, and the transmission apparatus 101D are set as an MIP (Maintenance Intermediate Point) indicating a relay point of a CCM frame. The MEP transmission apparatus 101A transmits a CCM frame to the opposite MEP transmission apparatus 101E via the MIP transmission apparatuses 101B, 101C, and 101D (Step S101). Upon receipt of the CCM frame from the transmission apparatus 101A, the MEP transmission apparatus 101E transmits the CCM frame to the opposite MEP transmission apparatus 101A via the MIP transmission apparatuses 101D, 101C, and 101B (Step S102). As a result, continuity between the MEP transmission apparatuses 101A and 101E can be checked.

At the management level “B1”, the transmission apparatus 101A, the transmission apparatus 101C, and the transmission apparatus 101E are set as an MEP, and the transmission apparatus 101B and the transmission apparatus 101D are set as an MIP. The MEP transmission apparatus 101A transmits a CCM frame to the MEP transmission apparatus 101C via the MIP transmission apparatus 101B (Step S103). Upon receipt of the CCM frame from the transmission apparatus 101A, the MEP transmission apparatus 101C transmits the CCM frame to the opposite MEP transmission apparatus 101E via the MIP transmission apparatus 101D (Step S103A). Upon receipt of the CCM frame from the transmission apparatus 101C, the MEP transmission apparatus 101E transmits the CCM frame to the MEP transmission apparatus 101C via the MIP transmission apparatus 101D (Step S104). Upon receipt of the CCM frame from the transmission apparatus 101E, the MEP transmission apparatus 101C transmits the CCM frame to the opposite MEP transmission apparatus 101A via the MIP transmission apparatus 101B (Step S104A). As a result, continuity between the MEP transmission apparatuses 101A, 101C, and 101E can be checked.

At the management level “C1”, the transmission apparatus 101A, the transmission apparatus 101B, the transmission apparatus 101C, the transmission apparatus 101D, and the transmission apparatus 101E are set as an MEP. The MEP transmission apparatus 101A transmits a CCM frame to the MEP transmission apparatus 101B (Step S105). Upon receipt of the CCM frame from the transmission apparatus 101A, the MEP transmission apparatus 101B transmits the CCM frame to the MEP transmission apparatus 101C (Step S105A). Upon receipt of the CCM frame from the transmission apparatus 101B, the MEP transmission apparatus 101C transmits the CCM frame to the MEP transmission apparatus 101D (Step S105B). Upon receipt of the CCM frame from the transmission apparatus 101C, the MEP transmission apparatus 101D transmits the CCM frame to the opposite MEP transmission apparatus 101E (Step S105C).

Upon receipt of the CCM frame from the transmission apparatus 101D, the MEP transmission apparatus 101E transmits the CCM frame to the MEP transmission apparatus 101D (Step S106). Upon receipt of the CCM frame from the transmission apparatus 101E, the MEP transmission apparatus 101D transmits the CCM frame to the MEP transmission apparatus 101C (Step S106A). Upon receipt of the CCM frame from the transmission apparatus 101D, the MEP transmission apparatus 101C transmits the CCM frame to the MEP transmission apparatus 101B (Step S106B). Upon receipt of the CCM frame from the transmission apparatus 101C, the MEP transmission apparatus 101B transmits the CCM frame to the MEP transmission apparatus 101A (Step S106C). As a result, continuity between the MEP transmission apparatuses 101A, 101B, 101C, 101D, and 101E can be checked.

[Patent document 1]: Japanese Laid-open Patent Publication No. 2008-236267

[Patent document 2]: Japanese Laid-open Patent Publication No. 2009-152727

However, transmission timing of a CCM frame transmitted from the MEP transmission apparatus 101 on a regular basis is the same at all the management levels. Therefore, a plurality of CCM frames are transmitted from the MEP transmission apparatus 101 at all the management levels at the same timing, so traffic is momentarily increased. Consequently, when respective timings for the opposite MEP transmission apparatus 101 to receive monitoring frames, such as the CCM frames at all the management levels, are the same timing or close to one another, the opposite MEP transmission apparatus 101 is congested with reception processing of the monitoring frames. As a result, the processing load on the MEP transmission apparatus 101 for the reception processing of the monitoring frames is increased, and therefore, hardware, such as a CPU or an L2 switch, has to be sophisticated to meet the maximum processing load.

### SUMMARY

According to an aspect of an embodiment of the invention, a transmission apparatus includes: a determining unit that determines whether reception processing of monitoring frames received from a plurality of transmission apparatuses is in a congestion state; a calculating unit that calculates an adjustment amount for adjusting transmission timing of each monitoring frame related to the transmission apparatus so as to decentralize reception processing of monitoring frames in case that the reception processing is in a congestion state; a transmitting unit that transmits the adjustment amount calculated by the calculating unit to a source transmission apparatus; and an adjusting unit that adjusts transmission timing of a monitoring frame to be transmitted to another transmission apparatus on the basis of an adjustment amount in case of receiving the adjustment amount from the another transmission apparatus.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is an explanatory diagram illustrating an example of a transmission system according to a first embodiment and management levels thereof;

FIG. 2 is a block diagram illustrating an example of a transmission apparatus according to the first embodiment;

FIG. 3 is an explanatory diagram illustrating an example of a format of a CCM frame;

FIG. 4 is an explanatory diagram illustrating an example of communication timing for an MEP at each management level to transmit a CCM frame;

FIG. 5 is a flowchart illustrating an example of processing operation of a CPU in the transmission apparatus involved in an adjustment-amount specifying process;

FIG. 6 is a flowchart illustrating an example of processing operation of the CPU in the transmission apparatus involved in a transmission-timing adjusting process;

FIG. 7 is an explanatory diagram illustrating a variation of the first embodiment;

FIG. 8 is a block diagram illustrating an example of a transmission apparatus according to a second embodiment; and

FIG. 9 is an explanatory diagram illustrating an example of a transmission system and management levels thereof.

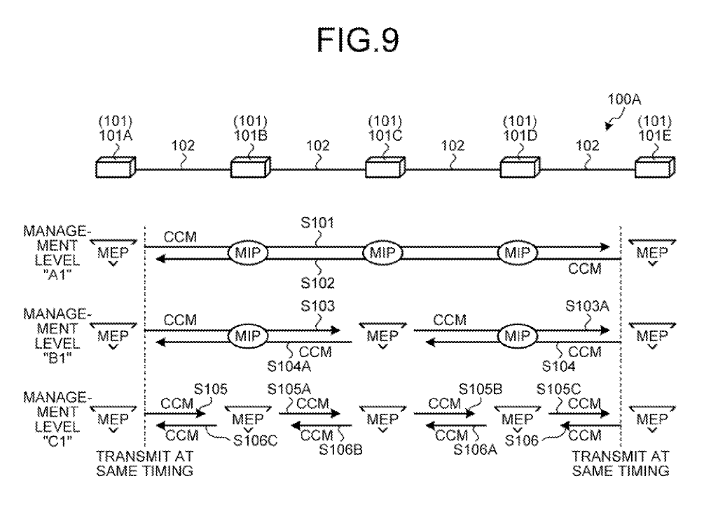

### DESCRIPTION OF EMBODIMENTS

Preferred embodiments of the present invention will be explained with reference to accompanying drawings. Incidentally, the present invention is not limited to the embodiments.

### [a]First Embodiment

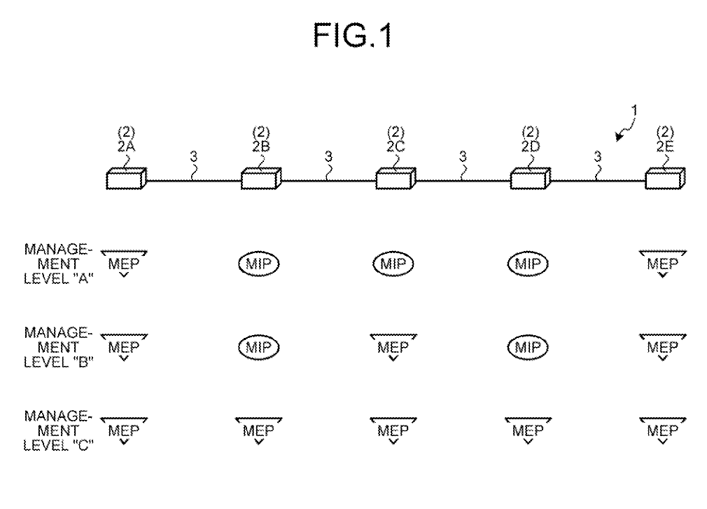

FIG. 1 is an explanatory diagram illustrating an example of a transmission system according to a first embodiment and management levels thereof. A transmission system 1 illustrated in FIG. 1 has, for example, a transmission apparatus 2A, a transmission apparatus 2B, a transmission apparatus 2C, a transmission apparatus 2D, and a transmission apparatus 2E; a transmission apparatus 2 is connected to another transmission apparatus 2 by a cable 3. Incidentally, the transmission system 1 has a plurality of management levels as a form of management in a maintenance section between the transmission apparatuses 2. In the example illustrated in FIG. 1, the transmission system 1 has three types of management levels: “A”, “B”, and “C”. At the management level “A”, the transmission apparatus 2A and the transmission apparatus 2E are set as an MEP, and the transmission apparatus 2B, the transmission apparatus 2C, and the transmission apparatus 2D are set as an MIP. Then, continuity between the MEP transmission apparatuses 2A and 2E is checked. At the management level “B”, the transmission apparatus 2A, the transmission apparatus 2C, and the transmission apparatus 2E are set as an MEP, and the transmission apparatus 2B and the transmission apparatus 2D are set as an MIP. Then, continuity between the MEP transmission apparatuses 2A, 2C, and 2E is checked. At the management level “C”, the transmission apparatus 2A, the transmission apparatus 2B, the transmission apparatus 2C, the transmission apparatus 2D, and the transmission apparatus 2E are set as an MEP. Then, continuity between the MEP transmission apparatuses 2A, 2B, 2C, 2D, and 2E is checked.

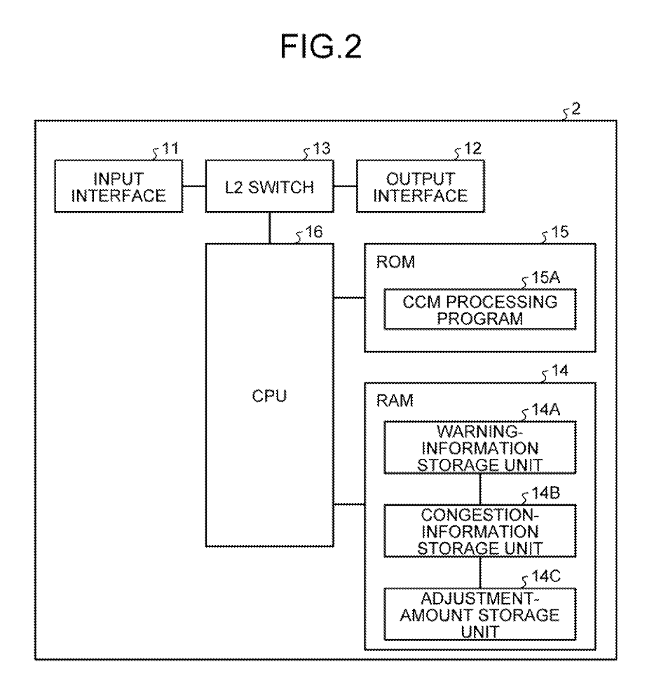

FIG. 2 is a block diagram illustrating an example of the transmission apparatus 2 according to the first embodiment. The transmission apparatus 2 illustrated in FIG. 2 includes an input interface 11, an output interface 12, an L2 switch 13, a random access memory (RAM) 14, a read-only memory (ROM) 15, and a central processing unit (CPU) 16. The input interface 11 is connected to the cable 3 and receives a frame or the like from another transmission apparatus 2 in the transmission system 1. The output interface 12 is connected to the cable 3 and outputs a frame or the like to another transmission apparatus 2 in the transmission system 1. The L2 switch 13 switches between the input interface 11 and the output interface 12, and performs various processing at the layer 2 level. In the RAM 14, a variety of information, for example, a warning-information storage unit 14A storing therein warning information, a congestion-information storage unit 14B storing therein congestion information, and an adjustment-amount storage unit 14C storing therein an adjustment amount to be described below have been stored. Incidentally, the warning information is, for example, information indicating a fault related to RDI information attached to a CCM frame. The congestion information is information indicating whether reception processing of a CCM frame is in a congestion state. The adjustment amount is an adjustment amount, i.e., an amount of adjustment of transmission timing of a CCM frame, which is added into a CCM frame as will be described later. The warning-information storage unit 14A, the congestion-information storage unit 14B, and the adjustment-amount storage unit 14C are configured to be stored in the single RAM 14; alternatively, they can be configured to be stored in a plurality of RAMs, respectively. In the ROM 15, various programs, for example, a CCM processing program 15A has been stored.

The CPU 16 controls the entire transmission apparatus 2, and reads out the CCM processing program stored in the ROM 15 and performs a CCM processing function. Incidentally, a determining unit, a calculating unit, and an adjusting unit in claims are implemented by the CPU 16. The CPU 16 receives a CCM frame via the input interface 11. The CPU 16 transmits a CCM frame via the output interface 12. The CPU 16 receives a CCM frame that the input interface 11 has received from another transmission apparatus 2. Furthermore, the CPU 16 analyzes a received CCM frame. Then, based on a result of the analysis, the CPU 16 determines whether there is warning information on the basis of RDI information included in the CCM frame. When there is warning information, the CPU 16 stores the warning information in the warning-information storage unit 14A.

Furthermore, the CPU 16 determines whether reception processing of the received CCM frame is in a congestion state on the basis of the result of the analysis. Incidentally, the congestion state is, for example, a state in which reception processing of a plurality of CCM frames at different management levels is congested upon reception of the CCM frames at the same timing or about the same timing within a transmission period defined in the CCM frames. When the reception processing is in a congestion state, the CPU 16 calculates an adjustment amount for adjusting the timing for the opposite MEP transmission apparatus 2 at each management level to transmit a CCM frame on the basis of the congestion state. Moreover, the CPU 16 determines whether an adjustment amount has been added into a particular area of the CCM frame received from the MEP transmission apparatus 2 on the basis of the result of the analysis. When an adjustment amount has been added into a particular area of the CCM frame, the CPU 16 detects the adjustment amount. Then, the CPU 16 stores the detected adjustment amount in the adjustment-amount storage unit 14C.

The CPU 16 generates a CCM frame to be transmitted to the opposite MEP transmission apparatus 2. Furthermore, when the CPU 16 has calculated an adjustment amount to be transmitted to the opposite MEP transmission apparatus 2, the CPU 16 adds the calculated adjustment amount into a particular area of the CCM frame to be transmitted to the opposite MEP transmission apparatus 2. Then, the CPU 16 transmits the generated CCM frame to the opposite MEP transmission apparatus 2. On the other hand, when the CPU 16 has detected an adjustment amount from a CCM frame, the CPU 16 adjusts transmission timing of the CCM frame to be transmitted to an opposite MEP transmission apparatus 2 on the basis of the adjustment amount. Then, the CPU 16 transmits the CCM frame to the opposite MEP transmission apparatus 2 on the basis of the adjusted transmission timing.

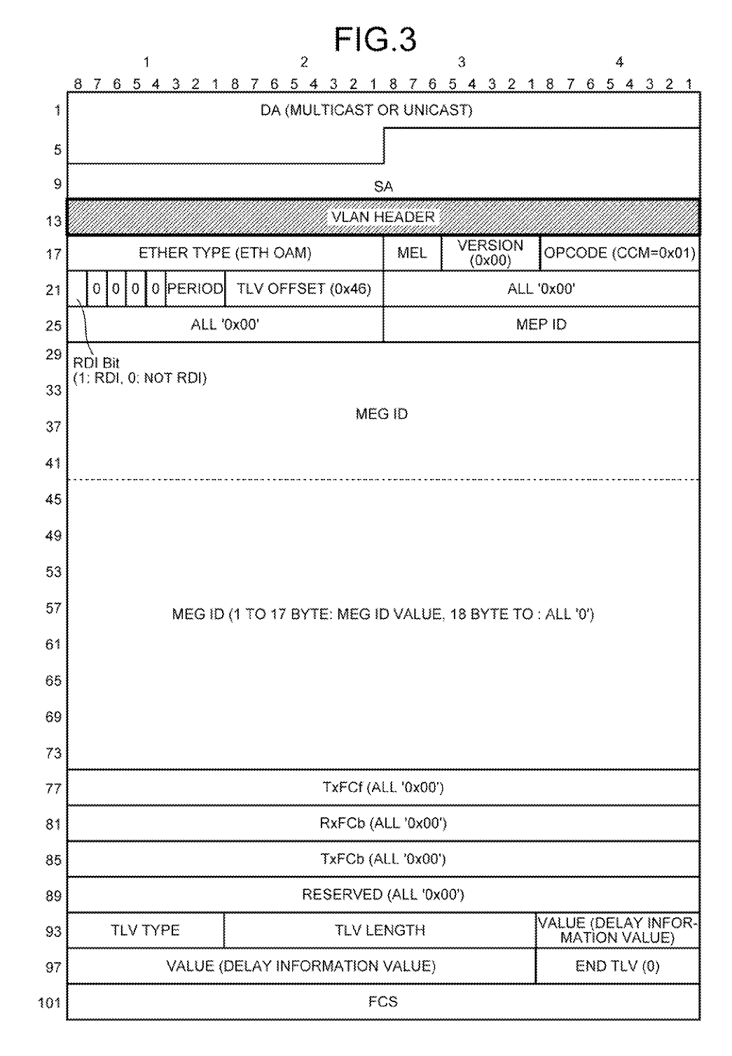

FIG. 3 is an explanatory diagram illustrating an example of a format of a CCM frame. The CCM frame illustrated in FIG. 3 has “DA”, “SA”, “VLAN header”, “Ether Type”, “MEL”, “Version”, “Opcode”, “RDI Bit”, and “Period”. Furthermore, the CCM frame has “TLV Offset”, “All “0x00””, “MEP ID”, “MEG ID”, “TxFCf”, “RxFCb”, and “TxFCb”. Moreover, the CCM frame has “Reserved”, “TLV type”, “TLV length”, “Value”, “End TLV”, and “FCS”.

“DA” is an area in which a multicast or unicast destination address is stored. “SA” is an area in which a MAC address of the apparatus is stored. “VLAN header” is an area in which header is stored. “Ether Type” is an area in which OAM is stored as a type of Ethernet. “MEL” is an area in which an MEG (Maintenance Entity Group) level of a source MEP is stored. Incidentally, MEG is an aggregation of ME (Maintenance Entity) indicating one section subject to maintenance using a CCM frame. “Version” is an area in which data for identifying whether to abandon reception is stored. “Opcode” is an area in which an op code for identifying an instruction is stored. “RDI Bit” is an area in which RDI information of a bit string for identifying content of a fault is stored. “Period” is an area in which a transmission/reception interval used in transmission/reception of a CCM frame is stored. “TLV Offset” is an area in which respective offset values of Type, Length, and Value of a CCM frame are stored. “All “0x00”” is an area in which an unused state of a sequence number is stored. “MEP ID” is an area in which an ID for identifying a source MEP is stored. “MEG ID” is an area in which an ID for identifying an MEG of the source MEP is stored.

“TxFCf” is an area in which a local counter at the transmission of a CCM frame is stored. “RxFCb” is an area in which a local counter at the reception of the last CCM frame from an opposite MEP is stored. “TxFCb” is an area in which the last TxFCf value at the reception of a CCM frame from an opposite MEP is stored. “Reserved” is a reserved area. “TLV type” is an area in the reserved area in which a frame type is stored. “TLV length” is an area in the reserved area in which a frame size is stored. “Value” is an area in the reserved area in which a value is stored. “FCS” is an area for error detection using checksum for detecting an error. Incidentally, “All “0x00”” in FIG. 3 indicates that the area is unused. Incidentally, the CPU 16 adds an adjustment value into a particular area of “TLV type”, “TLV length”, and “Value” in a CCM frame illustrated in FIG. 3.

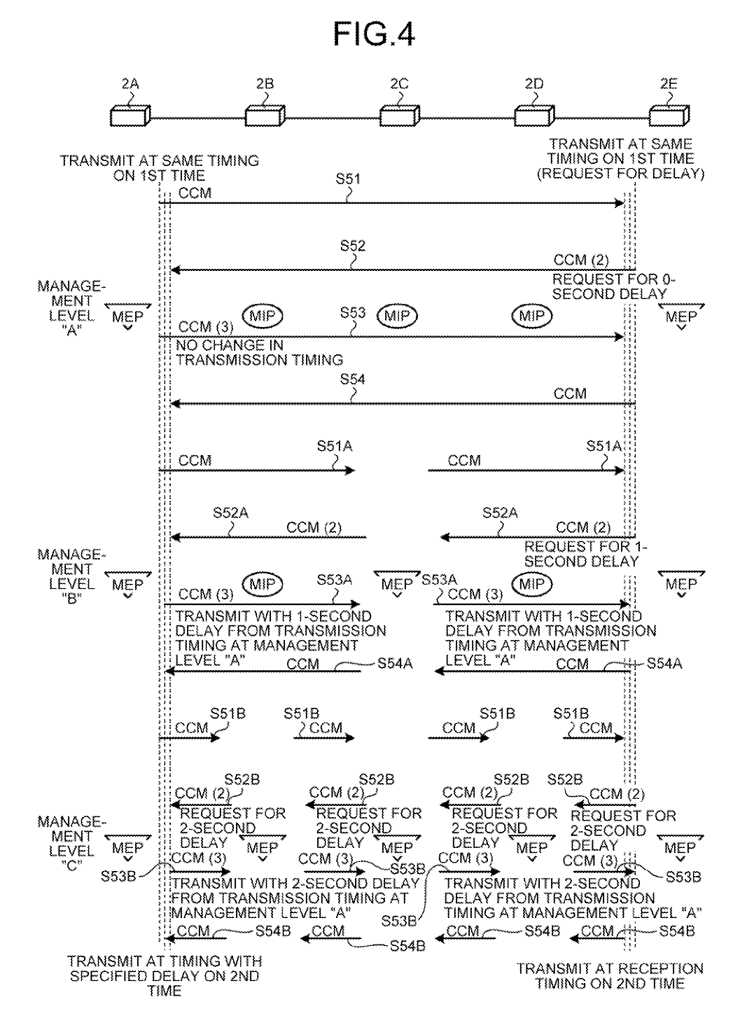

FIG. 4 is an explanatory diagram illustrating an example of communication timing for an MEP at each management level to transmit a CCM frame. At the management level “A”, the MEP transmission apparatus 2A transmits a CCM frame to the opposite MEP transmission apparatus 2E via MIPs. Upon receipt of the CCM frame from the transmission apparatus 2A, the MEP transmission apparatus 2E transmits the CCM frame to the opposite MEP transmission apparatus 2A via the MIPs. At the management level “B”, the MEP transmission apparatus 2A transmits a CCM frame to the MEP transmission apparatus 2C via an MIP. Upon receipt of the CCM frame from the transmission apparatus 2A, the MEP transmission apparatus 2C transmits the CCM frame to the opposite MEP transmission apparatus 2E via an MIP. Upon receipt of the CCM frame from the transmission apparatus 2C, the MEP transmission apparatus 2E transmits the CCM frame to the MEP transmission apparatus 2C via the MIP. Upon receipt of the CCM frame from the transmission apparatus 2E, the MEP transmission apparatus 2C transmits the CCM frame to the opposite MEP transmission apparatus 2A via the MIP.

At the management level “C”, the MEP transmission apparatus 2A transmits a CCM frame to the MEP transmission apparatus 2B. Upon receipt of the CCM frame from the transmission apparatus 2A, the MEP transmission apparatus 2B transmits the CCM frame to the opposite MEP transmission apparatus 2C. Upon receipt of the CCM frame from the transmission apparatus 2B, the MEP transmission apparatus 2C transmits the CCM frame to the MEP transmission apparatus 2D. Upon receipt of the CCM frame from the transmission apparatus 2C, the MEP transmission apparatus 2D transmits the CCM frame to the opposite MEP transmission apparatus 2E. Upon receipt of the CCM frame from the transmission apparatus 2D, the MEP transmission apparatus 2E transmits the CCM frame to the MEP transmission apparatus 2D. Upon receipt of the CCM frame from the transmission apparatus 2E, the MEP transmission apparatus 2D transmits the CCM frame to the opposite MEP transmission apparatus 2C. Upon receipt of the CCM frame from the transmission apparatus 2D, the MEP transmission apparatus 2C transmits the CCM frame to the MEP transmission apparatus 2B. Upon receipt of the CCM frame from the transmission apparatus 2C, the MEP transmission apparatus 2B transmits the CCM frame to the opposite MEP transmission apparatus 2A. Incidentally, respective timings for the transmission apparatus 2E, the receiving end MEP, to receive CCM frames at the management levels “A”, “B”, and “C” are the same timing depending on circumstances.

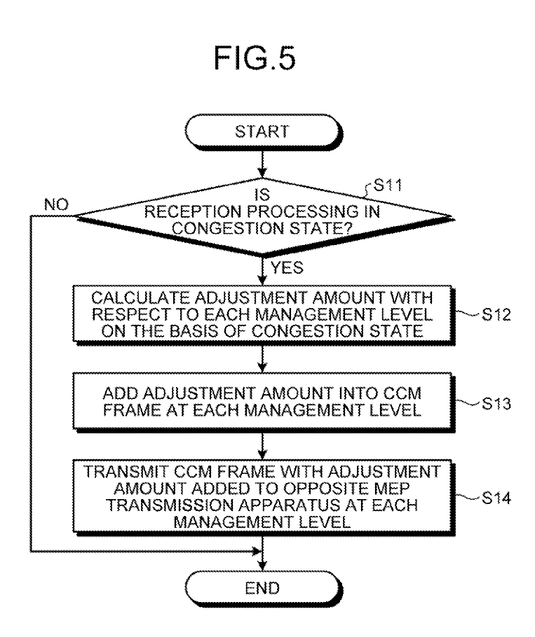

Subsequently, operation of the transmission system 1 according to the present embodiment is explained. FIG. 5 is a flowchart illustrating an example of processing operation of the CPU 16 of the transmission apparatus 2 involved in an adjustment-amount specifying process. The adjustment-amount specifying process illustrated in FIG. 5 is a process to give an opposite MEP transmission apparatus 2 an instruction on an adjustment amount for adjusting transmission timing of a CCM frame so that the MEP transmission apparatus 2 is not congested with reception processing of CCM frames at the respective management levels received from the opposite MEP transmission apparatus 2. In FIG. 5, the CPU 16 determines whether reception processing of a plurality of CCM frames at the respective management levels is in a congestion state (Step S11). In the example illustrated in FIG. 4, the MEP transmission apparatus 2A at the management levels “A”, “B”, and “C” transmits respective levels of CCM frames to the opposite MEP transmission apparatus 2E at the management levels “A”, “B”, and “C” at the same transmission timing (Steps S51, S51A, and S51B). As a result, the opposite MEP transmission apparatus 2E receives the CCM frames at the management levels “A”, “B”, and “C” at the same reception timing. Namely, the transmission apparatus 2E is congested with reception processing of the CCM frames.

When the reception processing is in a congestion state (YES at Step S11), the CPU 16 calculates an adjustment amount of transmission timing of a CCM frame at each management level on the basis of the congestion state (Step S12). Incidentally, the CPU 16 divides a normal CCM-frame transmission interval (for example, ten seconds) into predetermined units (for example, units of one second), and calculates the predetermined unit as an adjustment amount with respect to each management level. Namely, the CPU 16 delays the transmission timing of a CCM frame at each management level in increments of one second with increased management level. In the example illustrated in FIG. 4, when an adjustment amount of transmission timing of a CCM frame at the management level “A” is a 0-second delay as a reference value, an adjustment amount of transmission timing of a CCM frame at the management level “B” is a 1-second delay from the transmission timing at the management level “A”. Furthermore, an adjustment amount of transmission timing of a CCM frame at the management level “C” is a 1-second delay from the transmission timing at the management level “B”, i.e., a 2-second delay from the transmission timing at the management level “A”.

When calculated an adjustment amount at each management level, the CPU 16 adds the adjustment amount at each management level into a particular area of a CCM frame to be transmitted to an opposite MEP transmission apparatus 2 at the management level (Step S13). For example, the CPU 16 adds the adjustment amount at the management level “A”, i.e., a 0-second delay into a particular area of a CCM frame to be transmitted to an opposite MEP transmission apparatus 2 at the management level “A”. Furthermore, the CPU 16 adds the adjustment amount at the management level “B”, i.e., a 1-second delay into a particular area of a CCM frame to be transmitted to an opposite MEP transmission apparatus 2 at the management level “B”. Moreover, the CPU 16 adds the adjustment amount at the management level “C”, i.e., a 2-second delay into a particular area of a CCM frame to be transmitted to an opposite MEP transmission apparatus 2 at the management level “C”.

The CPU 16 transmits the CCM frame with the adjustment amount added to the opposite MEP transmission apparatus 2 at each management level (Step S14), and ends the processing operation illustrated in FIG. 5. In the example illustrated in FIG. 4, the CPU 16 transmits the CCM frame with the adjustment amount “0-second delay” added to the opposite MEP transmission apparatus 2 at the management level “A” (Step S52). Furthermore, the CPU 16 transmits the CCM frame with the adjustment amount “1-second delay” added to the opposite MEP transmission apparatus 2 at the management level “B” (Step S52A). Moreover, the CPU 16 transmits the CCM frame with the adjustment amount “2-second delay” added to the opposite MEP transmission apparatus 2 at the management level “C” (Step S52B). On the other hand, when there is no congestion of reception timing (NO at Step S11), the CPU 16 ends the processing operation illustrated in FIG. 5.

In the adjustment-amount specifying process illustrated in FIG. 5, when reception processing is in a congestion state, the CPU 16 calculates an adjustment amount for adjusting transmission timing of a CCM frame at each management level so as to avoid congestion of reception processing. Then, the CPU 16 transmits the CCM frame with the adjustment amount added at each management level to an opposite MEP transmission apparatus 2 at the management level. As a result, the MEP transmission apparatus 2 can notify an opposite MEP transmission apparatus 2 at each management level of an adjustment amount.

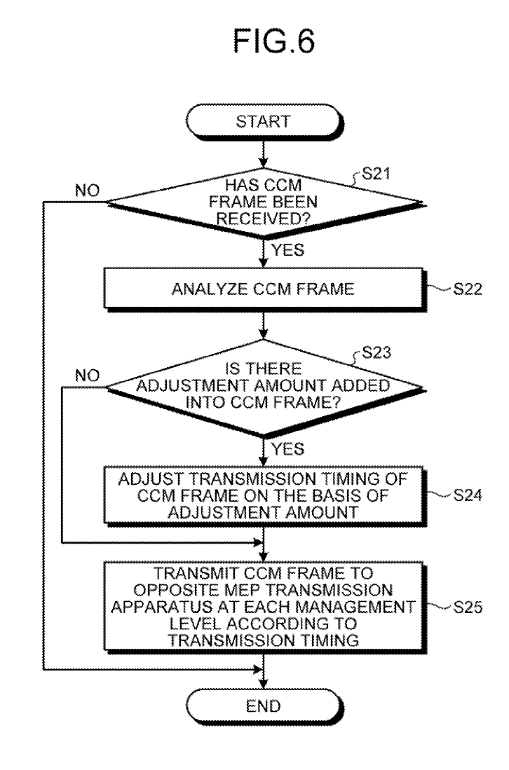

FIG. 6 is a flowchart illustrating an example of processing operation of the CPU 16 of the transmission apparatus 2 involved in a transmission-timing adjusting process. The transmission-timing adjusting process illustrated in FIG. 6 is a process to adjust transmission timing of a CCM frame to be transmitted to an opposite MEP transmission apparatus 2 to be delayed on the basis of an adjustment amount received from the opposite MEP transmission apparatus 2. In FIG. 6, the CPU 16 determines whether a CCM frame from the opposite MEP transmission apparatus 2 has been received (Step S21). When a CCM frame has been received (YES at Step S21), the CPU 16 analyzes the CCM frame received from the opposite MEP transmission apparatus 2 (Step S22).

The CPU 16 detects whether there is an adjustment amount added into a particular area of the CCM frame (Step S23). In the example illustrated in FIG. 4, the CPU 16 of the transmission apparatus 2A at the management level “A” detects the adjustment amount “0-second delay” from the CCM frame received from the opposite MEP transmission apparatus 2E at the management level “A”. Furthermore, the CPU 16 detects the adjustment amount “1-second delay” from the CCM frame received from the opposite MEP transmission apparatus 2E at the management level “B”. Moreover, the CPU 16 detects the adjustment amount “2-second delay” from the CCM frame received from the opposite MEP transmission apparatus 2E at the management level “C”.

When the CPU 16 has detected an adjustment amount added into a particular area of the CCM frame (YES at Step S23), the CPU 16 adjusts transmission timing of a CCM frame to be transmitted to the opposite MEP transmission apparatus 2 on the basis of the adjustment amount (Step S24). In the example illustrated in FIG. 4, the CPU 16 of the transmission apparatus 2A at the management level “A” adjusts transmission timing of a CCM frame to be transmitted to the opposite MEP transmission apparatus 2E to be delayed for 0 second on the basis of the adjustment amount “0-second delay” at the management level “A”. Furthermore, the CPU 16 adjusts transmission timing of a CCM frame at the management level “B” to be transmitted to the opposite MEP transmission apparatus 2E to be delayed for 1 second from the transmission timing at the management level “A” on the basis of the adjustment amount “1-second delay” at the management level “B”. Moreover, the CPU 16 adjusts transmission timing of a CCM frame at the management level “C” to be transmitted to the opposite MEP transmission apparatus 2E to be delayed for 2 seconds from the transmission timing at the management level “A” on the basis of the adjustment amount “2-second delay” at the management level “C”.

Then, the CPU 16 transmits the CCM frame to the opposite MEP transmission apparatus 2 at each management level on the basis of the adjusted transmission timing (Step S25), and ends the processing operation illustrated in FIG. 6. In the example illustrated in FIG. 4, the CPU 16 of the transmission apparatus 2A transmits the CCM frame to the opposite MEP transmission apparatus 2E at the management level “A” (Step S53). One second after the transmission of the CCM frame at Step S53, the CPU 16 transmits the CCM frame to the opposite MEP transmission apparatus 2E at the management level “B” (Step S53A). Two second after the transmission of the CCM frame at Step S53, i.e., one second after the transmission of the CCM frame at Step S53A, the CPU 16 transmits the CCM frame to the opposite MEP transmission apparatus 2E at the management level “C” (Step S53B). As a result, respective timings for the transmission apparatus 2A to transmit the CCM frames at the management levels “A”, “B”, and “C” are not the same timing, and therefore, it is possible to prevent a momentary increase in traffic in the transmission system 1.

Namely, one second after receiving the CCM frame at the management level “A”, the transmission apparatus 2E at the management levels “A”, “B”, and “C” receives the CCM frame at the management level “B”, and one second later, the transmission apparatus 2E receives the CCM frame at the management level “C”. As a result, the transmission apparatus 2E can sequentially perform reception processing of the CCM frame at each management level without congestion of reception processing of CCM frames. After that, in the example illustrated in FIG. 4, upon receipt of the CCM frame transmitted at the adjusted timing, the MEP transmission apparatus 2E at the management levels “A”, “B”, and “C” transmits the CCM frame to the opposite MEP transmission apparatus 2A (Steps S54, S54A, and S54B).

When a CCM frame has not been received from the opposite MEP transmission apparatus 2 (NO at Step S21), the CPU 16 ends the processing operation illustrated in FIG. 6. Furthermore, when the CPU 16 has detected no adjustment amount added into a particular area of the CCM frame (NO at Step S23), the process proceeds to Step S25 at which the CPU 16 transmits the CCM frame to the opposite MEP transmission apparatus 2 on the basis of the transmission timing as is.

In the transmission-timing adjusting process illustrated in FIG. 6, the CPU 16 adjusts transmission timing of a CCM frame at each management level on the basis of an adjustment amount added into the CCM frame. The CPU 16 transmits the CCM frame to the opposite MEP transmission apparatus 2 at the management level at the transmission timing adjusted on the basis of the adjustment amount. The CPU 16 of the MEP transmission apparatus 2 at each management level sequentially receives a CCM frame transmitted from an opposite MEP transmission apparatus 2 at the management level. As a result, the MEP transmission apparatus 2 is not congested with reception processing of the CCM frame, and therefore, the processing load on the MEP transmission apparatus 2 required for the reception processing can be reduced by the decentralized CCM-frame reception processing.

In the first embodiment, when the receiving MEP transmission apparatus 2 is congested with reception processing, the MEP transmission apparatus 2 transmits an adjustment amount of transmission timing of a CCM frame at each management level to an opposite MEP transmission apparatus 2 at the management level. The opposite MEP transmission apparatus 2 adjusts transmission timing of a CCM frame to be transmitted to the MEP transmission apparatus 2 on the basis of the adjustment amount, and transmits the CCM frame at the adjusted transmission timing. Therefore, the MEP transmission apparatus 2 at each management level sequentially receives a CCM frame from an opposite MEP transmission apparatus 2 at the management level. As a result, the MEP transmission apparatus 2 is not congested with reception processing of the CCM frame, and therefore, the processing load on the MEP transmission apparatus 2 required for the reception processing can be reduced by the decentralized CCM-frame reception processing. In addition, the processing load required for reception processing is reduced, so an inexpensive, low-end CPU or L2 switch can be applied, resulting in reduction of component cost of the transmission apparatus 2.

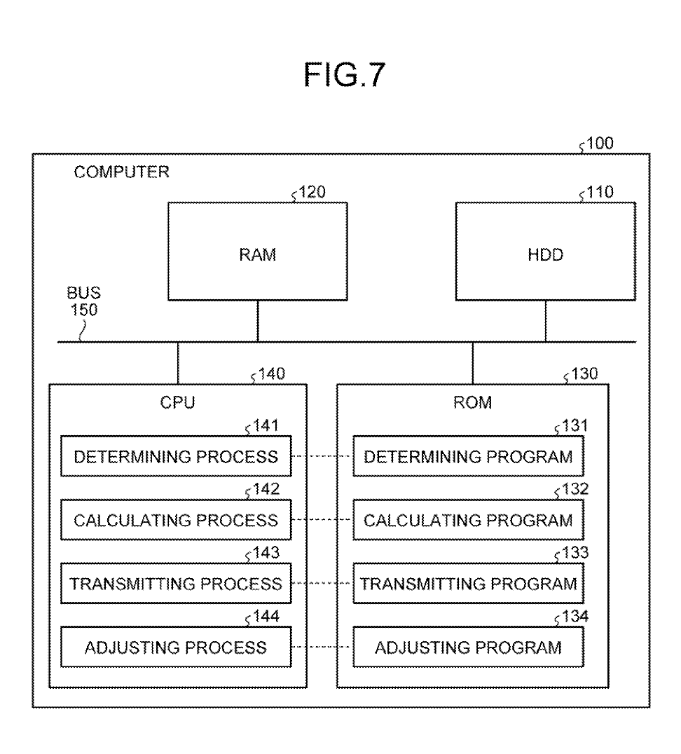

The processes described in the first embodiment can be implemented by causing a computer to execute a program prepared in advance. As a variation of the first embodiment, an example of a computer that executes a program is explained below with reference to FIG. 7. FIG. 7 is an explanatory diagram illustrating the variation of the first embodiment.

As illustrated in FIG. 7, in a computer 100 that execute a transmission program, a hard disk drive (HDD) 110, a RAM 120, a ROM 130, and a CPU 140 are connected to one another by a bus 150.

The transmission program, which fulfills the same functions as those described in the above embodiment, has been stored in the ROM 130 or the HDD 110 in advance. Incidentally, instead of storing the transmission program in the ROM 130 or the HDD 110, the transmission program can be recorded on a computer-readable recording medium that the computer 100 can read by putting it into a drive (not illustrated). The recording medium can be a portable recording medium, such as a CD-ROM, a DVD, or a USB memory, or a semiconductor memory such as a flash memory. As illustrated in FIG. 7, a determining program 131, a calculating program 132, a transmitting program 133, and an adjusting program 134 have been stored in the ROM 130 as the transmission program.

The CPU 140 reads out these programs 131 to 134 from the ROM 130 and executes the read programs 131 to 134. Then, the programs 131 to 134 function as a determining process 141, a calculating process 142, a transmitting process 143, and an adjusting process 144, respectively.

The CPU 140 determines whether reception processing of a monitoring frame received from an opposite MEP transmission apparatus is in a congestion state. When the reception processing is in a congestion state, the CPU 140 calculates an adjustment amount for adjusting transmission timing of a monitoring frame related to a source transmission apparatus so as to decentralize reception processing of monitoring frames. Then, the CPU 140 transmits the calculated adjustment amount to the source transmission apparatus. On the other hand, when received an adjustment amount from another transmission apparatus 2, the CPU 140 adjusts transmission timing of a monitoring frame to be transmitted to the transmission apparatus on the basis of the adjustment amount. As a result, the reception processing is not congested, and therefore, the processing load on the CPU 140 can be reduced by the decentralized CCM-frame reception processing.

Incidentally, in the first embodiment, the CPU 16 performs the CCM processing program; alternatively, a CCM processing circuit for performing CCM processing can be provided separately from the CPU 16 so as to reduce the load on the CPU 16. Such a configuration is explained below as a second embodiment.

### [b] Second Embodiment

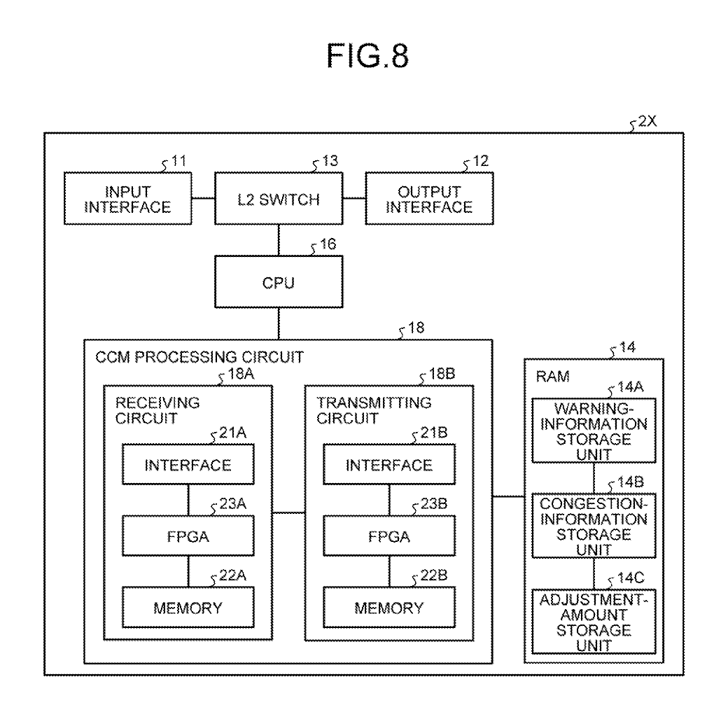

FIG. 8 is a block diagram illustrating an example of a transmission apparatus according to the second embodiment. Incidentally, a component having the same configuration as that of the transmission apparatus 2 illustrated in FIG. 2 is denoted by the same reference numeral, and description of the configuration and operation of the component is omitted. A transmission apparatus 2X illustrated in FIG. 8 incorporates a CCM processing circuit 18 in addition to the input interface 11, the output interface 12, the L2 switch 13, the RAM 14, and the CPU 16. Incidentally, the CCM processing circuit 18 is composed of a semiconductor device, such as an FPGA (Field Programmable Gate Array) or an ASIC (Application Specific Integrated Circuit).

The CCM processing circuit 18 includes a receiving circuit 18A and a transmitting circuit 18B. The receiving circuit 18A has an interface 21A, a memory 22A, and an FPGA 23A. A reception processing program related to a CCM frame has been stored in the memory 22A. The FPGA 23A reads out the reception processing program stored in the memory 22A and performs a reception processing function. The FPGA 23A receives a CCM frame, which the input interface 11 has received from another transmission apparatus 2X, via the interface 21A. The FPGA 23A analyzes the received CCM frame. Based on a result of the analysis, the FPGA 23A determines whether there is warning information on the basis of RDI information included in the CCM frame. When there is warning information, the FPGA 23A stores the warning information in the warning-information storage unit 14A.

Furthermore, the FPGA 23A determines whether reception processing of the received CCM frame is in a congestion state on the basis of the result of the analysis. Incidentally, the congestion state is, for example, a state in which reception processing of a plurality of CCM frames at different management levels is congested upon reception of the CCM frames at the same timing or about the same timing within a transmission period defined in the CCM frames. When the reception processing is in a congestion state, the FPGA 23A calculates an adjustment amount for adjusting the timing for an opposite MEP transmission apparatus 2X at each management level to transmit a CCM frame on the basis of the congestion state. Moreover, the FPGA 23A determines whether an adjustment amount has been added into a particular area of the CCM frame received from the MEP transmission apparatus 2X on the basis of the result of the analysis. When an adjustment amount has been added into a particular area of the CCM frame, the FPGA 23A detects the adjustment amount. Then, the FPGA 23A stores the detected adjustment amount in the adjustment-amount storage unit 14C.

The transmitting circuit 18B has an interface 21B, a memory 22B, and an FPGA 23B. A transmission processing program related to a CCM frame has been stored in the memory 22B. The FPGA 23B reads out the transmission processing program stored in the memory 22B and performs a transmission processing function. The FPGA 23B generates a CCM frame to be transmitted to an opposite MEP transmission apparatus 2X. Furthermore, when the FPGA 23B has calculated an adjustment amount to be transmitted to the opposite MEP transmission apparatus 2X, the FPGA 23B adds the calculated adjustment amount into a particular area of the CCM frame to be transmitted to the opposite MEP transmission apparatus 2X. Then, the FPGA 23B transmits the generated CCM frame to the opposite MEP transmission apparatus 2X. On the other hand, when the FPGA 23B has detected an adjustment amount from a CCM frame, the FPGA 23B adjusts transmission timing of the CCM frame to be transmitted to an opposite MEP transmission apparatus 2X on the basis of the adjustment amount. Then, the FPGA 23B transmits the CCM frame to the opposite MEP transmission apparatus 2X on the basis of the adjusted transmission timing.

The CCM processing circuit 18 performs the adjustment-amount specifying process illustrated in FIG. 5. Namely, when reception processing is in a congestion state, the CCM processing circuit 18 calculates an adjustment amount for adjusting the transmission timing of a CCM frame at each management level so as to avoid congestion of reception processing. Then, the CCM processing circuit 18 transmits the CCM frame with the adjustment amount added at each management level to an opposite MEP transmission apparatus 2X at the management level. As a result, an MEP transmission apparatus 2X can notify an opposite MEP transmission apparatus 2X at each management level of an adjustment amount.

Furthermore, the CCM processing circuit 18 performs the transmission-timing adjusting process illustrated in FIG. 6. Namely, the CCM processing circuit 18 adjusts the transmission timing of a CCM frame at each management level on the basis of an adjustment amount added into the CCM frame at the management level. Then, the CCM processing circuit 18 transmits the CCM frame to an opposite MEP transmission apparatus 2X at the management level at the transmission timing adjusted on the basis of the adjustment amount. The CCM processing circuit 18 of the MEP transmission apparatus 2X at each management level sequentially receives a CCM frame from an opposite MEP transmission apparatus 2X at the management level. As a result, the MEP transmission apparatus 2X is not congested with reception processing of the CCM frame, and therefore, the processing load on the MEP transmission apparatus 2X can be reduced by the decentralized CCM-frame reception processing.

In the second embodiment, when a receiving MEP transmission apparatus 2X is congested with reception processing, the CCM processing circuit 18 transmits an adjustment amount for adjusting the transmission timing of a CCM frame at each management level to an opposite MEP transmission apparatus 2X at the management level. The CCM processing circuit 18 of the opposite MEP transmission apparatus 2X adjusts the transmission timing of a CCM frame on the basis of the adjustment amount, and transmits the CCM frame at the adjusted transmission timing. The CCM processing circuit 18 of an MEP transmission apparatus 2X at each management level sequentially receives a CCM frame from an opposite MEP transmission apparatus 2X at the management level. As a result, the CCM processing circuit 18 of the MEP transmission apparatus 2X is not congested with reception processing of the CCM frame, and therefore, the processing load on the CCM processing circuit 18 required for reception processing can be reduced by the decentralized CCM-frame reception processing. Furthermore, the processing load required for reception processing is reduced, so an inexpensive, low-end CPU or L2 switch can be applied, resulting in reduction of component cost of the transmission apparatus 2X. In addition, the CCM processing circuit 18 performs the CCM processing, so the load on the CPU 16 can be reduced.

Incidentally, in the above embodiment, with respect to each management level, a receiving MEP transmission apparatus 2X notifies an opposite MEP transmission apparatus 2X of an adjustment amount of transmission timing of a CCM frame related to the opposite MEP transmission apparatus 2X. Alternatively, regardless of management level, each receiving MEP transmission apparatus 2X can calculate an adjustment amount of transmission timing of a CCM frame and notify an opposite MEP transmission apparatus 2X of the adjustment amount.

Furthermore, in the above embodiment, a normal transmission interval is divided into predetermined units, for example, units of one second, and the transmission timing of a CCM frame is adjusted to be delayed in increments of one second with increased management level. Alternatively, based on a normal transmission interval and the number of CCM frames at all management levels received in the normal transmission interval, an adjustment amount per CCM frame can be calculated by dividing the normal transmission interval by the number of CCM frames. For example, in a case where a normal transmission interval is ten seconds and the number of received CCM frames at the five management levels “A” to “E” is five, an adjustment amount per frame is two seconds (10÷5). An adjustment amount at the management level “A” is a “0-second delay”, an adjustment amount at the management level “B” is a “2-second delay” from the transmission timing at the management level “A”, an adjustment amount at the management level “C” is a “4-second delay” from the transmission timing at the management level “A”, an adjustment amount at the management level “D” is a “6-second delay” from the transmission timing at the management level “A”, and an adjustment amount at the management level “E” is an “8-second delay” from the transmission timing at the management level “A”.

Moreover, in the above embodiment, the transmission timing is adjusted to be delayed on the basis of an adjustment amount; alternatively, reception processing can be decentralized by adjusting the transmission timing to be pushed forward.

Furthermore, all or any part of the processing functions performed in each apparatus can be performed on the CPU (or a microcomputer, such as a micro processing unit (MPU) or a micro controller unit (MCU)). Moreover, needless to say, all or any part of the processing functions can be performed on a program that is analyzed and executed by the CPU (or a microcomputer, such as an MPU or an MCU) or hardware by wired logic.

The processing load can be reduced by decentralization of reception processing of monitoring frames.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a determining unit that determines whether reception processing of monitoring frames received from a plurality of transmission apparatuses is in a congestion state;
a calculating unit that calculates an adjustment amount for adjusting transmission timing of each monitoring frame related to the transmission apparatus so as to decentralize reception processing of monitoring frames in case that the reception processing is in a congestion state;
a transmitting unit that transmits the adjustment amount calculated by the calculating unit to a source transmission apparatus; and
an adjusting unit that adjusts transmission timing of a monitoring frame to be transmitted to another transmission apparatus on the basis of an adjustment amount in case of receiving the adjustment amount from the another transmission apparatus.

2. The transmission apparatus according to claim 1, wherein the calculating unit calculates the adjustment amount with respect to each management level for managing maintenance between terminating transmission apparatuses specified with a terminating transmission apparatus or a relaying transmission apparatus in the plurality of transmission apparatuses.

3. The transmission apparatus according to claim 2, wherein the determining unit determines whether reception processing of a monitoring frame at each management level is in a congestion state at predetermined transmission intervals defined in the monitoring frame.

4. A method for transmission of a monitoring frame between transmission apparatuses, the method comprising:
causing the transmission apparatus to execute:
determining whether reception processing of monitoring frames received from a plurality of other transmission apparatuses is in a congestion state;
calculating an adjustment amount for adjusting transmission timing of each monitoring frame related to the transmission apparatus so as to decentralize reception processing of monitoring frames in case that the reception processing is in a congestion state; and
transmitting the adjustment amount to a source transmission apparatus, and
causing the source transmission apparatus to execute:
adjusting transmission timing of a monitoring frame to be transmitted to another transmission apparatus on the basis of an adjustment amount in case of receiving the adjustment amount from the another transmission apparatus.

5. A non-transitory computer readable storage medium having stored therein a transmission program, the transmission program causing a computer to execute a process comprising:
determining whether reception processing of monitoring frames received from a plurality of transmission apparatuses is in a congestion state;
calculating an adjustment amount for adjusting transmission timing of each monitoring frame related to the transmission apparatus so as to decentralize reception processing of monitoring frames in case that the reception processing is in a congestion state; and
transmitting the calculated adjustment amount to a source transmission apparatus.

6. A transmission apparatus comprising:
a memory; and
a processor that executes a program stored in the memory, wherein
the program causing the processor to execute:
determining whether reception processing of monitoring frames received from a plurality of transmission apparatuses is in a congestion state;
calculating an adjustment amount for adjusting transmission timing of each monitoring frame related to the transmission apparatus so as to decentralize reception processing of monitoring frames in case that the reception processing is in a congestion state; and
transmitting the calculated adjustment amount to a source transmission apparatus.

7. The transmission apparatus according to claim 6, wherein the calculating includes calculating an adjustment amount with respect to each management level for managing maintenance between terminating transmission apparatuses specified with a terminating transmission apparatus or a relaying transmission apparatus in the plurality of transmission apparatuses.

8. The transmission apparatus according to claim 7, wherein the determining includes determining whether reception processing of a monitoring frame at each management level is in a congestion state at predetermined transmission intervals defined in the monitoring frame.
